(19) United States
(12) Patent Application Publication
(10) Pub. No.: US 2017/0088092 A1
(43) Pub. Date: Mar. 30, 2017

(54) ANCHOR FOR SEATBELT DEVICE

(71) Applicant: KABUSHIKI KAISHA TOKAI-RIKA-DENKI-SEISAKUSHO, Aichi (JP)

(72) Inventors: Masanori UKAI, Aichi (JP); Tomotaka SUZUKI, Aichi (JP)

(21) Appl. No.: 15/312,154

(22) PCT Filed: May 19, 2015
(86) PCT No.: PCT/JP2015/064337

§ 371 Date: Nov. 17, 2016

(30) Foreign Application Priority Data
Jun. 4, 2014 (JP) 2014-116049

(51) Int. Cl. B60R 22/18; B60R 22/20

(52) U.S. Cl. CPC B60R 22/18; B60R 22/201

(57) ABSTRACT

At a present through anchor, a through-hole is formed in a core metal. Due thereto, at the core metal, there is no metal portion of the core metal at a portion MF that is furthest from an outer peripheral portion of the core metal and a supporting hole and an insert-through hole. Accordingly, because there is no need for a heat treatment such as quenching or the like at the furthest portion MF and a periphery thereof, dispersion in mechanical characteristics at respective regions of the core metal after a heat treatment can be made to be small.

### TECHNICAL FIELD

The present invention relates to an anchor for a seatbelt device that is for supporting a webbing of a seatbelt device.

### BACKGROUND ART

A through anchor, that is a form of an anchor for a seatbelt device, has a core metal that is formed of a steel plate material (as an example, refer to Japanese Patent Application Laid-Open (JP-A) No. 2006-36186). A heat treatment such as quenching or the like is carried out on this core metal. However, it takes time for the heat treatment at regions of the core metal that are far from the outer peripheral portion thereof for example, and, as a result, dispersion in the mechanical properties, such as the hardness and the mechanical strength and the like, arises at the respective regions of the core metal.

### SUMMARY OF INVENTION

### Technical Problem

In view of the above-described circumstances, an object of the present invention is to provide an anchor for a seatbelt device that can make small the dispersion in the mechanical properties of a core metal after a heat treatment.

### Solution to Problem

An anchor for a seatbelt device of a first aspect of the present invention comprises: a core metal that is formed of metal and is subjected to a heat treatment; an insert-through hole that is formed in the core metal, and at which a webbing for passenger restraint is inserted-through and supported; a supporting hole that is formed in the core metal, and through which a supporting member, that is fixed to a vehicle body side, is passed; and a lightening portion that is formed at the core metal separately from the insert-through hole and the supporting hole.

At the anchor for a seatbelt device of the first aspect of the present invention, the lightening portion, that is formed at the core metal separately from the insert-through hole and the supporting hole, does not require a heat treatment, or the time of the heat treatment can be made to be uniform at the lightening portion and at regions other than the lightening portion. Therefore, dispersion in the mechanical properties at the respective regions of the core metal after a heat treatment becomes small.

In an anchor for a seatbelt device of a second aspect of the present invention, in the anchor for a seatbelt device of the first aspect, the lightening portion passes-through in a thickness direction of the core metal.

In accordance with the anchor for a seatbelt device of the second aspect of the present invention, because there is no metal portion at the lightening portion of the core metal, there is no need for a heat treatment at the lightening portion. Due thereto, dispersion in the mechanical properties at the respective regions of the core metal becomes small.

In an anchor for a seatbelt device of a third aspect of the present invention, in the anchor for a seatbelt device of the first aspect, at the lightening portion, a thickness of the core metal is formed to be thinner than other regions of the core metal.

In accordance with the anchor for a seatbelt device of the third aspect of the present invention, because the lightening portion is formed to be thinner than the other regions of the core metal, the heat treatment can be carried out in a short time. Due thereto, the time of the heat treatment can be made to be uniform at the lightening portion and at the regions other than the lightening portion. Therefore, dispersion in the mechanical properties at the respective regions of the core metal after a heat treatment becomes small.

In an anchor for a seatbelt device of a fourth aspect of the present invention, in the anchor for a seatbelt device of any one of the first through third aspects, the lightening portion is formed at a portion, that includes a position furthest from an outer peripheral portion of the core metal, at a central side of the core metal.

At the anchor for a seatbelt device of the fourth aspect of the present invention, the portion, that includes the position furthest from the outer peripheral portion of the core metal, at the central side of the core metal does not require a heat treatment, or the time of the heat treatment can be made to be uniform at the lightening portion and at regions other than the lightening portion. Therefore, dispersion in the mechanical properties at the respective regions of the core metal after a heat treatment becomes small.

In an anchor for a seatbelt device of a fifth aspect of the present invention, in the anchor for a seatbelt device of any one of the first through fourth aspects, the lightening portion is formed at the core metal between the insert-through hole and the supporting hole.

At the anchor for a seatbelt device of the fifth aspect of the present invention, the lightening portion is formed at the core metal between the insert-through hole and the supporting hole, and therefore, a heat treatment is not needed between the insert-through hole and the supporting hole, or the time of the heat treatment can be made to be uniform at the lightening portion and at regions other than the lightening portion. Therefore, dispersion in the mechanical properties at the respective regions of the core metal becomes small.

In an anchor for a seatbelt device of a sixth aspect of the present invention, in the anchor for a seatbelt device of the third aspect, the lightening portion is formed at a periphery of the supporting hole.

At the anchor for a seatbelt device of the sixth aspect of the present invention, the lightening portion is formed at a periphery of the supporting hole through which the supporting member is passed, and the core metal is formed to be thin at this lightening portion. Therefore, recess portions, which are recessed in the thickness direction of the core metal, can be formed in the core metal at the periphery of the supporting hole. Due thereto, for example, the end portions of the supporting member, or another member that is passed-through the supporting hole together with the supporting member, can be accommodated partially within the recess portions. Therefore, there is no projecting-out, from the supporting hole, of the supporting member or of the other member that is passed-through the supporting hole together with the supporting member, or the projecting-out dimension can be made to be short.

In an anchor for a seatbelt device of a seventh aspect of the present invention, in the anchor for a seatbelt device of any one of the first through sixth aspects, an entirety of the core metal is covered by a molding that is formed of a synthetic resin material.

At the anchor for a seatbelt device of the seventh aspect of the present invention, the entire core metal is covered by the molding that is formed of a synthetic resin material. Therefore, an anti-corrosion treatment of the core metal is unnecessary.

### Advantageous Effects of Invention

As described above, at the anchor for a seatbelt device relating to the present invention, dispersion in the mechanical properties of the core metal after a heat treatment can be made to be small.

### BRIEF DESCRIPTION OF DRAWINGS

FIG. 1 is a front view of an anchor for a seatbelt device relating to a first embodiment.

FIG. 2 is a cross-sectional view, along line 2-2 of FIG. 1, showing a mounted state of the anchor for a seatbelt device relating to the first embodiment.

FIG. 3 is a cross-sectional view that corresponds to FIG. 2 and that shows an anchor for a seatbelt device relating to a second embodiment.

FIG. 4 is a cross-sectional view that corresponds to FIG. 2 and that shows an anchor for a seatbelt device relating to a third embodiment.

### DESCRIPTION OF EMBODIMENTS

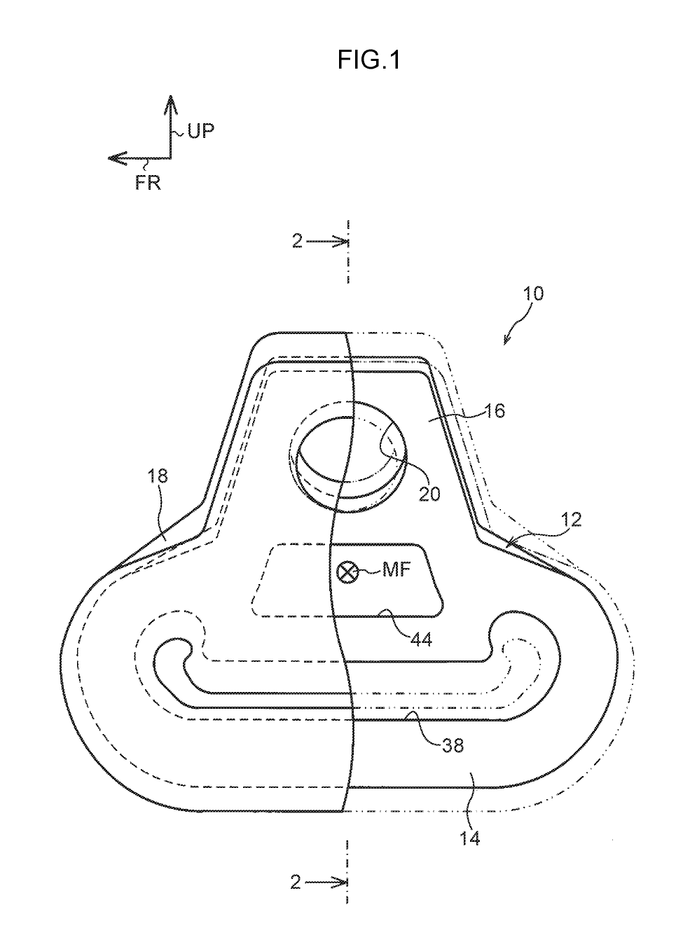

Respective embodiments of the present invention are described next by using the respective drawings of FIG. 1 through FIG. 4. Note that, in the respective drawings, arrow FR indicates the vehicle forward side to which a through anchor 10, that serves as an anchor for a seatbelt device, is applied, arrow LH indicates the vehicle left side, and arrow UP indicates the vehicle upper side. Further, the respective embodiments that are described hereinafter explain cases in which the through anchor 10 corresponds to a seat at the right side of a vehicle.

### Structure of First Embodiment

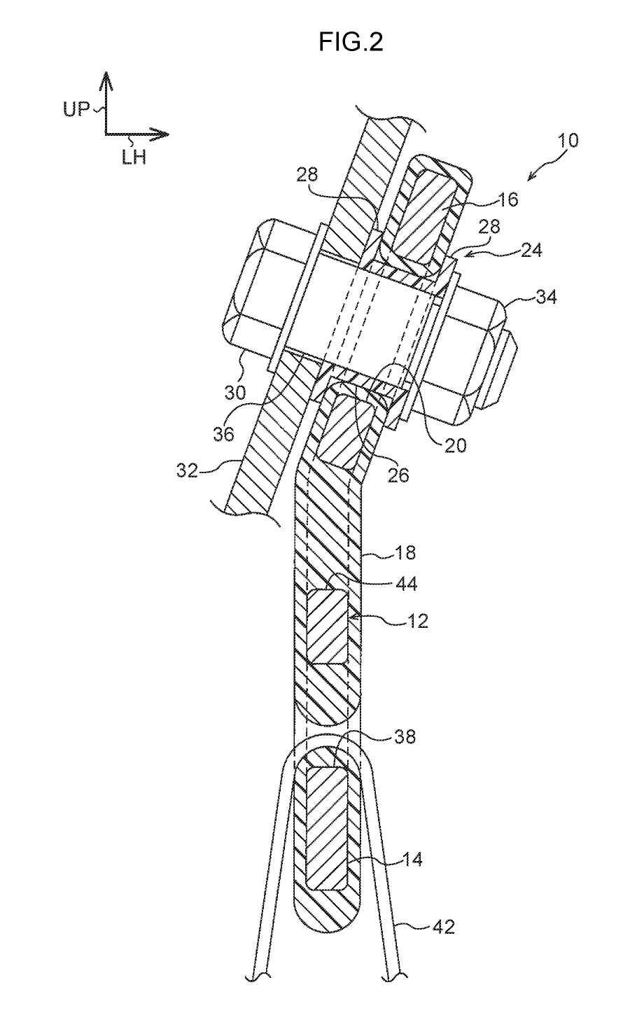

As shown in FIG. 1 and FIG. 2, the through anchor 10 relating to the first embodiment has a core metal 12. The core metal 12 is formed by press molding a metal plate material such as a steel plate material or the like, and carrying out a heat treatment such as quenching or the like thereon. The core metal 12 has a core metal lower portion 14. The length direction of the core metal lower portion 14 runs along the vehicle longitudinal direction, and the thickness direction runs along the vehicle left-right direction. A core metal upper portion 16 is formed at the vehicle longitudinal direction intermediate portion of the upper end portion of the core metal lower portion 14. The core metal upper portion 16 is made to be a substantially trapezoidal shape whose vehicle longitudinal direction dimension is shorter than the core metal lower portion 14, and extends-out obliquely leftward and upward from the vehicle longitudinal direction intermediate portion of the core metal lower portion 14. This core metal 12 is covered by a molding 18 that is made of a synthetic resin material. The molding 18 is formed by, for example, insert molding in which a synthetic resin material is filled within a molding die in a state in which the core metal 12 is placed within the molding die.

A supporting hole 20 that is substantially circular is formed in the core metal upper portion 16 of the core metal 12, so as to pass-through in the thickness direction of the core metal upper portion 16, and the inner side surface of the supporting hole 20 is covered by the molding 18. As shown in FIG. 2, a bush 24 is inserted in the supporting hole 20 that is covered by the molding 18. The bush 24 has a tube portion 26 that is tubular. The axial direction dimension of the tube portion 26 is set to be equal to the thickness direction of the portion, in which the supporting hole 20 is formed, of the through anchor 10. Flanges 28, which are circular, extend-out toward outer sides in a direction orthogonal to the axial direction of the tube portion 26, from the both ends of the tube portion 26.

A shoulder bolt 30 that serves as a supporting member is passed-through the bush 24 from the vehicle right side. The shoulder bolt 30 passes-through a supporting body 32, such as the slider or the like of an anchor height adjusting device that is provided at the center pillar at the vehicle right side, and is passed-through the bush 24 and screwed-together with a nut 34 at the vehicle left side of the supporting body 32. Due thereto, the through anchor 10 is supported at the vehicle body so as to be able to rotate around a shaft portion 36 of the shoulder bolt 30.

Further, as shown in FIG. 1 and FIG. 2, an insert-through hole 38 is formed so as to pass-through the core metal lower portion 14 of the core metal 12, in the thickness direction of the core metal lower portion 14. The inner side surface of the insert-through hole 38 is covered by the molding 18. The length direction of the insert-through hole 38 that is covered by the molding 18 runs along the vehicle longitudinal direction, and is made into the shape of a slit whose opening width in the vehicle vertical direction is short. As shown in FIG. 2, a webbing 42 for passenger restraint of a seatbelt device is inserted-through the insert-through hole 38, and, due thereto, the webbing 42 is supported by the through anchor 10.

The length direction proximal end portion of the webbing 42 is anchored on the spool of a webbing retractor that is provided in a vicinity of the lower end portion of the center pillar at the right side of a vehicle seat, and the length direction distal end portion of the webbing 42 is fixed to the floor portion or the like of the vehicle via an anchor plate that is provided at the right side of the seat. The portion of the webbing 42, which portion is between the anchor plate and the through anchor 10, is inserted-through a slit hole that is formed in a tongue, and the body of a passenger is restrained by the webbing 42 due to the tongue being engaged with a buckle, that is provided at the left side of the vehicle seat, in a state in which the webbing 42 is placed around the body of the passenger seated in the seat.

On the other hand, a through-hole 44 serving as a lightening portion is formed at the core metal 12. The through-hole 44 is formed so as to extend over the core metal lower portion 14 and the core metal upper portion 16, between the insert-through hole 38 of the core metal lower portion 14 and the supporting hole 20 of the core metal upper portion 16. The through-hole 44 is substantially trapezoidal as seen in a front view (as seen from the vehicle left side), and passes-through in the thickness direction of the core metal 12. Note that, as examples of the position where the through-hole 44 is formed, there are at least one of the portion that would become the largest clump of metal at the core metal 12 if the through-hole 44 were not to be formed, the substantially central portion between the insert-through hole 38 of the core metal lower portion 14 and the supporting hole 20 of the core metal upper portion 16 and the vehicle longitudinal direction central portion of the core metal 12.

Due to the through-hole 44 being formed at the core metal 12, at the core metal 12, there is no metal portion of the core metal 12 at a portion MF that is furthest from the outer peripheral portion of the core metal 12 and the supporting hole 20 and the insert-through hole 38. The synthetic resin material of the molding 18 is filled into the inner side of this through-hole 44, and, in a state in which the molding 18 has been applied, a hole that passes-through in the thickness direction of the through anchor 10 is not formed at the position where the through-hole 44 is formed. In this way, at the present through anchor 10, the synthetic resin material of the molding 18 is filled into the inner side of the through-hole 44, and further, the inner side surfaces of the supporting hole 20 and the insert-through hole 38 are covered by the molding 18. Therefore, the entire core metal 12 is covered by the molding 18.

### Operation and Effects of First Embodiment

At the present through anchor 10, the core metal 12 is formed due to a metal plate material such as a steel plate material or the like being press-molded by a press mold and being subjected to a heat treatment such as quenching, annealing, normalizing, tempering or the like. Next, in a state in which the core metal 12 is placed within a molding mold, a synthetic resin material is filled into the molding mold, and, due thereto, the core metal 12 is covered by the molding 18.

Here, in the present embodiment, the through-hole 44 is formed between the insert-through hole 38 and the supporting hole 20 of the core metal 12. Therefore, at the core metal 12, there is no metal portion of the core metal 12 at the portion MF that is furthest from the outer peripheral portion of the core metal 12 and the supporting hole 20 and the insert-through hole 38, and at the peripheral portion of the furthest portion MF, and therefore, there is no need for a heat treatment at these portions. Due thereto, the dispersion in the mechanical characteristics at the respective regions of the core metal 12 can be made to be small. Furthermore, there is no metal portion of the core metal 12 at the furthest portion MF and the peripheral portion thereof, and therefore, there is no need for a heat treatment at this portion, and thus, the time required for the heat treatment of the core metal 12 can be shortened.

In particular, in a case in which the core metal 12 is formed by die quenching, the steel plate material that is the material of the core metal 12 is heated to a temperature appropriate for quenching, and, in this state, the steel plate material is press-molded by a press mold, and due to the contact between the press mold and the steel plate material, the steel plate material is cooled and quenched. Here, at the core metal 12, there is no metal portion of the core metal 12 at the portion MF that is furthest from the outer peripheral portion of the core metal 12 and the supporting hole 20 and the insert-through hole 38.

Therefore, in the present embodiment, there is no need to carry out quenching on this furthest portion MF, and it suffices to not take into consideration the cooling time of the furthest portion MF and the peripheral portion thereof. Accordingly, because the core metal 12 can overall be rapidly cooled by the contact between the core metal 12 and the press mold, the dispersion in the mechanical properties after quenching can be made to be small at the respective regions of the core metal 12. Furthermore, there is no need to carry out quenching at the furthest portion MF, and it suffices to not take into consideration the cooling time of the furthest portion MF and the peripheral portion thereof, and therefore, the entire core metal 12 can be quenched in a short time.

Moreover, in the present embodiment, the synthetic resin material of the molding 18 is filled-in in the inner side of the through-hole 44 of the core metal 12, and further, the inner side surfaces of the supporting hole 20 and the insert-through hole 38 of the core metal 12 are covered by the molding 18. Due thereto, the entire core metal 12 is covered by the molding 18, and the core metal 12 is not exposed, and therefore, corrosion of the core metal 12 can be prevented or suppressed. Therefore, there is no need to carry out an anti-corrosion treatment such as a plating treatment or the like on the core metal 12, and the number of manufacturing steps of the through anchor 10 can be reduced.

Note that, in the present embodiment, there is a structure in which the synthetic resin material of the molding 18 is filled-in in the inner side of the through-hole 44, but there may be a structure in which the inner side surface of the through-hole 44 is covered by the molding, and, at the molding 18, a hole that passes-through in the thickness direction of the through anchor 10 is formed at a position corresponding to the through-hole 44.

### Second Embodiment

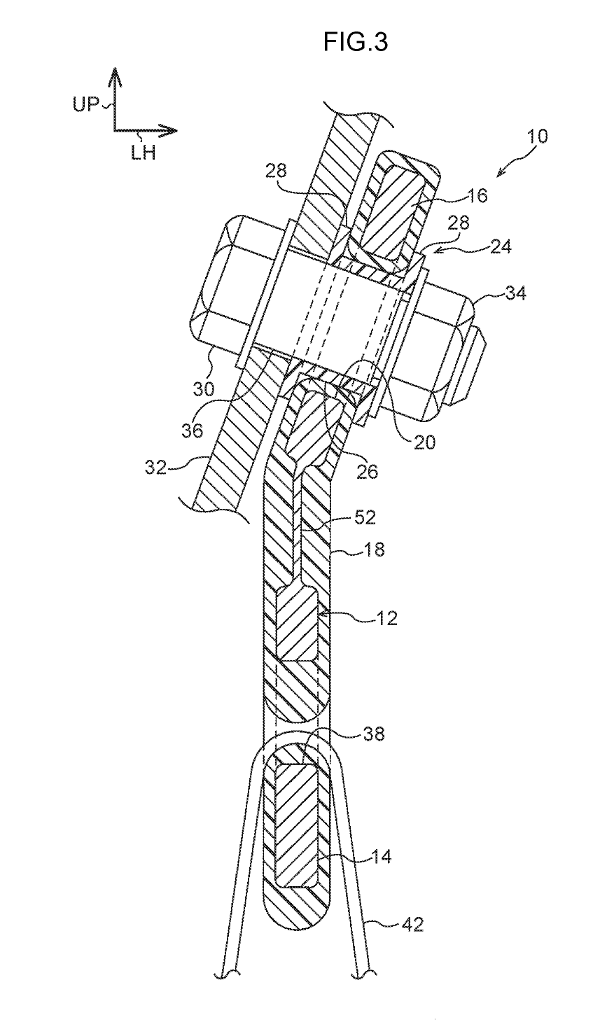

As shown in FIG. 3, in the second embodiment, a thin-walled portion 52, which serves as the lightening portion in place of the through-hole 44, is formed in the core metal 12. At the thin-walled portion 52, the thickness of the core metal 12 is set so as to be thin as compared with regions other than the thin-walled portion 52, and the thin-walled portion 52 is formed at the thickness direction substantially central portion of the core metal 12. Therefore, even though the central side (the portion including the furthest portion MF in the above-described first embodiment) of the thin-walled portion 52 is far from the outer peripheral portion of the core metal 12 and the supporting hole 20 and the insert-through hole 38 that are formed in the core metal 12, the heat treatment such as quenching or the like is completed in a short time. Due thereto, dispersion in the mechanical characteristics as the respective regions of the core metal 12 can be made to be small.

Further, in the present embodiment, there is a structure in which the thin-walled portion 52 is formed at the thickness direction substantially central portion of the core metal 12. However, the thin-walled portion 52 may be formed so as to be offset toward one side in the thickness direction of the core metal 12.

Moreover, in the above-described respective embodiments, the shapes of the through-hole 44 and the thin-walled portion 52 that serve as lightening portions are made to be substantially trapezoidal as seen in a front view. However, the shape of the lightening portion is not limited to trapezoidal, and the shape of the lightening portion may be an arbitrary shape such as circular, triangular, or the like. Further, in the above-described respective embodiments, the number of the through-hole 44 and the thin-walled portion 52 that serve as the lightening portion is 1, but plural lightening portions may be provided.

### Third Embodiment

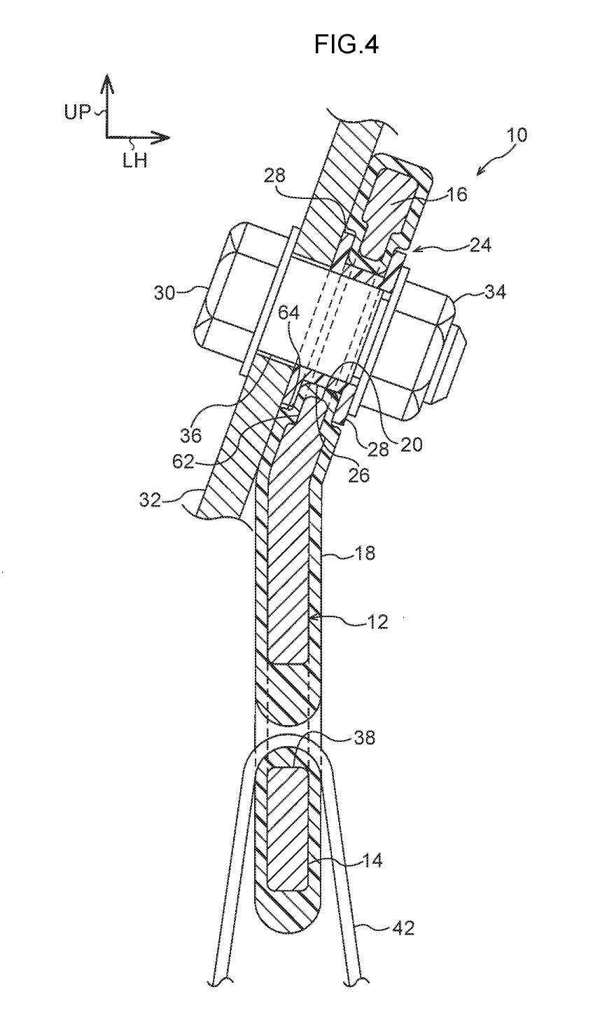

As shown in FIG. 4, in the third embodiment, a thin-walled portion 62 that serves as the lightening portion is formed in the core metal upper portion 16 of the core metal 12. At the thin-walled portion 62, the thickness of the core metal upper portion 16 is set so as to be thin as compared with regions other than the thin-walled portion 62, and the thin-walled portion 62 is formed at the thickness direction substantial center of the core metal upper portion 16. Further, the thin-walled portion 62 is substantially circular, and the supporting hole 20 is formed so as to pass-through the radial direction substantial center of the thin-walled portion 62 (in other words, the thin-walled portion 62 is formed in an annular shape adjacent to the supporting hole 20 at the radial direction outer side of the supporting hole 20). Due thereto, in the present embodiment, concave portions that are annular can be formed in the thickness direction both sides of the core metal upper portion 16 of the core metal 12, at the periphery of the supporting hole 20.

Further, the thickness of the molding 18 that is applied to the thin-walled portion 62 is set to be thinner than the molding 18 that is applied to regions of the core metal 12 other than the thin-walled portion 62. Due thereto, flange accommodating holes 64, that are circular and are recessed in the thickness direction of the core metal upper portion 16, are formed coaxially with the supporting hole 20 at the portion of the molding 18 which portion corresponds to the thin-walled portion 62 of the core metal upper portion 16. The diameter dimension of the flange accommodating holes 64 is set to be larger than the outer diameter dimension of the flanges 28 of the bush 24, and further, the depth dimension of the flange accommodating holes 64 is set to be comparable to the thickness dimension of the flanges 28 of the bush 24. Further, in the present embodiment, the axial direction dimension of the tube portion 26 of the bush 24 is equal to the interval between the bottom portion of the one flange accommodating hole 64 and the bottom portion of the other flange accommodating hole 64, and to the thickness of the regions, other than the thin-walled portion 62, of the through anchor 10.

Therefore, in the state in which the bush 24 is mounted to the through anchor 10, the entire flanges 28 of the bush 24, or the majorities thereof, are accommodated in the flange accommodating holes 64. Due thereto, the flanges 28 of the bush 24 projecting-out from the surfaces of the through anchor 10 can be prevented or effectively reduced. Due thereto, a bush, that is used in a conventional through anchor and at which a thin-walled portion and a molding are not applied to the periphery of the supporting hole at the core metal, can be applied to the present through anchor 10.

Note that, in the above-described respective embodiments, there is a structure in which the shoulder bolt 30, that serves as the supporting member and that is passed-through the supporting body 32 from the vehicle right side, is passed-through the bush 24 that is provided in the supporting hole 20. However, there may be a structure in which a shoulder bolt, that is passed-through the bush 24 from the vehicle left side, is passed-through the supporting body 32 and is screwed-together with the nut 34. Further, in the above-described respective embodiments, the shoulder bolt 30 and the supporting body 32 are structured by separate bodies, but there may be a structure in which the shoulder bolt 30 is formed integrally with the supporting body 32.

Moreover, in the present embodiment, the thin-walled portion 62 is formed adjacent to the supporting hole 20 at the radial direction outer side of the supporting hole 20. However, the place where the thin-walled portion 62 is formed may be formed at a region other than the outer side of the supporting hole 20, such as at the outer side of the insert-through hole 38 or the like.

Further, in the present embodiment, the thickness of the molding 18 that is applied to the thin-walled portion 62 is set to be thinner than the molding 18 that is applied to regions of the core metal 12 other than the thin-walled portion 62. However, the thickness of the molding 18 that is applied to the thin-walled portion may be the same thickness as the molding 18 that is applied to regions other than the thin-walled portion, or may be thicker than the molding 18 that is applied to regions other than the thin-walled portion. For example, by setting the molding 18 that is applied to the thin-walled portion to be thicker than the molding 18 that is applied to regions other than the thin-walled portion, the strength of the molding 18 that is applied to the thin-walled portion can be made to be higher than the molding 18 that is applied to the other regions.

Moreover, in the above-described respective embodiments, there is a structure in which the present invention is applied to a through anchor. However, for example, the present invention can be applied widely without being limited to a through anchor, provided that it is a member that supports a webbing, such as, for example, an anchor plate at which the distal end portion of a webbing is supported, a tongue through which the webbing is inserted between an anchor plate and a through anchor, or the like.

The disclosure of Japanese Patent Application No. 2014-116049 filed on Jun. 4, 2014 is, in its entirety, incorporated by reference into the present specification.

1. An anchor for a seatbelt device, comprising:
a core metal that is formed of metal and is subjected to a heat treatment;
an insert-through hole that is formed in the core metal, and at which a webbing for passenger restraint is inserted-through and supported;
a supporting hole that is formed in the core metal, and through which a supporting member, that is fixed to a vehicle body side, is passed; and
a lightening portion that is formed at the core metal separately from the insert-through hole and the supporting hole.

2. The anchor for a seatbelt device of claim 1, wherein the lightening portion passes-through in a thickness direction of the core metal.

3. The anchor for a seatbelt device of claim 1, wherein, at the lightening portion, a thickness of the core metal is formed to be thinner than other regions of the core metal.

4. The anchor for a seatbelt device of claim 1, wherein the lightening portion is formed at a portion, that includes a position furthest from an outer peripheral portion of the core metal, at a central side of the core metal.

5. The anchor for a seatbelt device of claim 1, wherein the lightening portion is formed at the core metal between the insert-through hole and the supporting hole.

6. The anchor for a seatbelt device of claim 3, wherein the lightening portion is formed at a periphery of the supporting hole.

7. The anchor for a seatbelt device of claim 1, wherein an entirety of the core metal is covered by a molding that is formed of a synthetic resin material.
